(19) United States
(12) Patent Application Publication
(10) Pub. No.: US 2005/0197845 A1
(43) Pub. Date: Sep. 8, 2005

(54) Business workbook precalculation

(76) Inventors: Kai Wachter, Dossenheim (DE); Markus Ulke, Heidelberg (DE)

Correspondence Address: FISH & RICHARDSON, P.C., PO BOX 1022, MINNEAPOLIS, MN, 55440-1022, US

(21) Appl. No.: 10/792,436

(22) Filed: Mar. 2, 2004

(51) Int. Cl. G06F 17/60

(52) U.S. Cl. 705/1; 705/9; 705/10

(57) ABSTRACT

Systems and techniques relating to business workbook precalculation facilitate analysis of business activity. In general, in one implementation, a technique includes: receiving a business workbook to be precalculated, the business workbook including report information concerning business activity and query information used in updating the report information, initiating precalculation of the business workbook in response to receipt of the business workbook, interpreting the business workbook to identify the query information, sending the query information to a remote processing system, precalculating the business workbook based on information received in response to the sent query information, and forwarding the precalculated business workbook to facilitate analysis of the business activity. Additionally, a security mechanism of a back-end system can be sidestepped and maintained by starting an in-process server in a process on a front-end system, and receiving in the in-process server a call from the back-end system to establish a connection over a channel.

### BACKGROUND

The following description relates to systems and techniques for maintaining and analyzing business activity information, for example, updating business workbooks in batch mode to facilitate analysis of business activity.

Data warehousing involves combining multiple different databases across a business enterprise, typically as a collection of data designed to support management decision making. Business warehouse systems can pull data from multiple back-end systems in an enterprise, and combine the data to present a coherent picture of business conditions at a point in time. Business warehouse systems have been integrated with general purpose spreadsheet applications to facilitate use of the business warehouse functionality. For example, the SAP® Business Warehouse (BW) system provided by SAP AG of Walldorf, Germany, has been integrated with the Excel application program provided by Microsoft Corporation of Redmond, Wash.; this integration allows the SAP® BW system to maintain business workbooks in the native format of the Excel program while retaining the ability to handle queries native to the SAP® BW system.

### SUMMARY

Systems and techniques relating to business workbook precalculation facilitate analysis of business activity. According to an aspect, a technique includes: receiving a business workbook to be precalculated, the business workbook including report information concerning business activity and query information used in updating the report information, initiating precalculation of the business workbook in response to receipt of the business workbook, interpreting the business workbook to identify the query information, sending the query information to a remote processing system, precalculating the business workbook based on information received in response to the sent query information, and forwarding the precalculated business workbook to facilitate analysis of the business activity. Additionally, a security mechanism of a back-end system can be sidestepped and maintained, where the security mechanism prevents a connection from a front-end system to the back-end system from being shared over different process identifiers in a multitasking operating system of the front-end system, by starting an in-process server in a newly invoked process on the front-end system, and receiving in the in-process server a call from the back-end system to establish a connection over a channel.

According to another aspect, a system includes first and second processing systems. The first processing system includes at least one data server and is configured to provide information about business activity, to retain a business workbook including report information concerning business activity and query information used to update the report information, and to send the business workbook to the second processing system for update. The second processing system is configured to receive the business workbook, start an application process capable of reading the business workbook, and start an in-process server capable of receiving a call from the first processing system to establish a connection for the application process.

Details of one or more implementations are set forth in the accompanying drawings and the description below. Other features and advantages may be apparent from the description and drawings, and from the claims.

### DRAWING DESCRIPTIONS

FIG. 1 is a block diagram illustrating a business workbook precalculation system.

FIG. 2 is a block diagram illustrating components of a business workbook precalculation system.

FIG. 3 is a flowchart illustrating business workbook precalculation.

FIG. 4 is a block diagram illustrating a business workbook precalculation system.

FIG. 5 illustrates an example administrative interface.

Like reference symbols in the various drawings indicate like elements.

### DETAILED DESCRIPTION

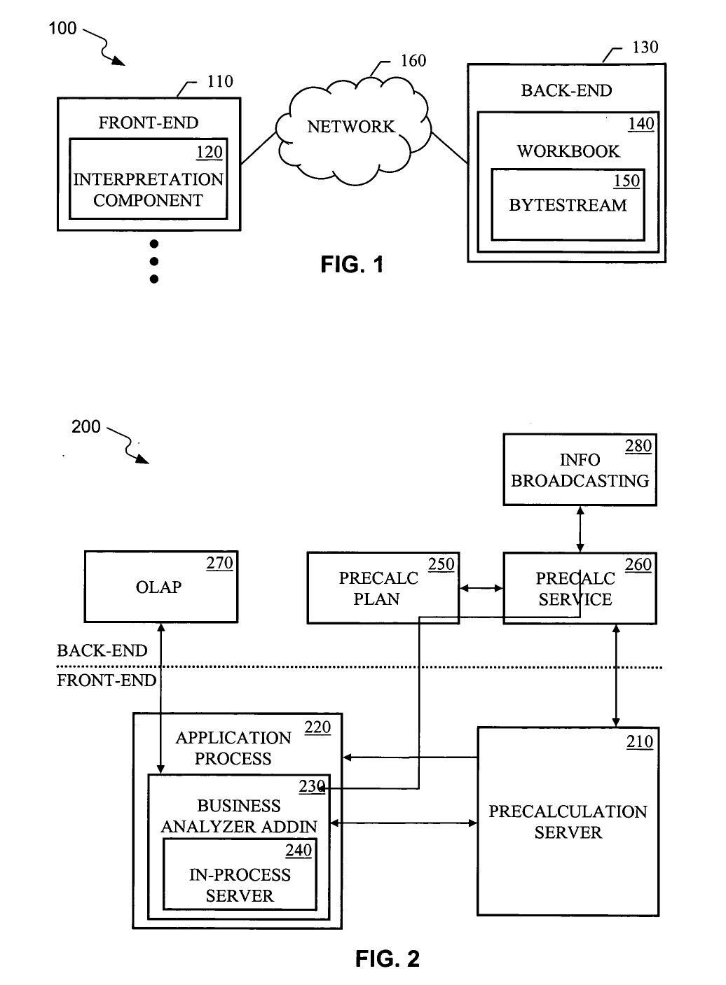

The systems and techniques described here relate to maintaining and analyzing business activity information. FIG. 1 is a block diagram illustrating a business workbook precalculation system 100. The system 100 includes a front-end system 110 and a back-end system 130. The back-end system 130 can be a business warehouse information server system (e.g., the SAP® BW system provided by SAP AG of Walldorf, Germany), and the front-end system 110 can be a client computer having a graphical user interface and an application process (e.g., the Excel application program provided by Microsoft Corporation of Redmond, Wash.). The front-end and back-end systems 110, 130 are interconnected by a network 160, allowing data communication between the two.

The front-end system 110 includes an interpretation component 120 (e.g., a software application, or portion thereof) that understands and can interpret information in a bytestream. The bytestream is binary information in a format specific to a particular software program. The back-end system 130 includes one or more workbooks 140 that include a bytestream 150, which can be understood through the interpretation component 120. The workbook(s) 140 are business workbook(s) that include report information concerning business activity and query information used in updating the report information. A workbook 140 can be stored as the bytestream 150 (i.e., the workbook 140 and the bytestream 150 can be coextensive). The report information to be updated can come from any of several different information sources, including the back-end system 130. Moreover, the back-end system 130 need not include an interpretation component, and thus may not be able to directly interpret the bytestream 150.

Mutliple front-end systems 110 can communicate with the back-end system 130, where the front-end systems 110 can have different processor architectures provided they include an appropriate interpretation component 120. The interpretation component 120 can be part of an operating system (OS) of a system 110 and/or part of an application process (e.g., Excel). For example, a business workbook 140 can be a Microsoft Excel file with several worksheets. One or more of the front-end systems 110 can be used to manually access, update, and analyze business workbooks stored in the back-end system 130. The business workbooks can be stored in multiple bytestreams in the back-end system 130, and one or more back-end system queries (i.e., queries in a format useable by the back-end system 130) can be inserted into a business workbook. Moreover, a query can be inserted into a workbook multiple times to cause presentation of different views of the data at the same time.

For example, a front-end system 110 can include a business analyzer addin for a software application, such as Excel. The business analyzer addin can be the front-end tool used to get reports from a business warehouse system. The business analyzer tool can be used to open queries and/or workbooks, and a workbook can be an Excel spreadsheet with a customized tool bar. Different users can thus customize their Excel program to be their own business analyzer. One or more queries in a workbook can be defined to pull data from various departments of a business enterprise, and the workbook can be used to generate multiple reports through the back-end system 130. Queries can be modified, including by adding filters to the queries used when generating reports, and all such query information can be saved back to the workbook, which can be stored in the back-end system 130 (e.g., the business analyzer tool can take the workbook on the local file system, read the byte content and send this information back to the back-end system 130, which can save the bytestream in a table, from which the workbook can be pulled and opened again at the front-end system 110).

One or more of the front-end systems 110 can be used to automatically precalculate business workbooks (e.g., update the information in multiple workbooks in batch mode in advance of their planned use) to improve the efficiency of the system 100 and facilitate analysis of business activity. A precalculation front-end system 110 can include a server process used in initiating precalculation of a business workbook. The front-end system 110 can interpret the bytestream of a workbook and communicate with the back-end system 130 to handle processing of back-end system data included in the workbook. For example, updating a workbook can involve interpreting the bytestream at the front-end system 110 to identify queries, and sending the queries to the back-end system 130 to obtain information from other systems that then updates the workbook on the front-end system 110. Additionally, the system 100 can employ communication security measures that restrict the ability of a process running on the front-end 110 to see a connection established between a different process on the front-end 110 and the back-end system 130. To address this security issue, a connection overhand protocol can be used to establish a new connection to the back-end system 130 in response to a request to precalculate a business workbook.

FIG. 2 is a block diagram illustrating components of a business workbook precalculation system 200. The back-end of the system 200 can include an information broadcasting component 280 used to distribute information (e.g., workbooks, queries, reports) around the back-end system. Precalculation can be initiated within the report-broadcasting functionality of the information broadcasting component 280 and/or by executing a precalculation plan 250. In either event, a precalculation service 260 can be used; the precalculation service 260 can include one or more class definitions to implment the functionality described.

The precalculation service 260 can call a precalculation server 210 running on the front-end of the system 200. The precalculation service 260 can include with this call, process identifier information, such as a generic GUID (globally unique identifier) or session ID generated for an in-process server 240. The precalculation service 260 can include additional information with this call to the precalculation server 210, such as gateway_host and gateway_service information. The precalculation server 210 can then start an application process 220 and load a business analyzer addin 230, which can in turn start the in-process server 240. The in-process server 240 can register itself at the back-end gateway, and the precalculation service 260 can call in a new task against the in-process server 240 to establish the new connection. At this point, the business analyzer addin 230 now has an established connection with the back-end over a channel (e.g., the Internet).

Both the precalculation server 210 and the in-process server 240 can be considered RFC (remote function call) servers in that the back-end can call these programs running on the front-end. Calling the in-process server 240 from the back-end allows the system 200 to accommodate a process security mechanism in which the back-end prevents a connection with the back-end from being shared among different system processes with different process identifiers in a multitasking operating system (e.g., different Windows® processes in a Windows® operating system). Because a separate instance of the application process 220 can be invoked in order to update a workbook, a connection for a new instance of the business analyzer addin 230 needs to be established with the back-end. By calling the in-process server 240 from the back-end, the connection is set up and gets its own connection handle. Thus, separate connections are established for the two different system processes 210, 220.

After the precalculation service 260 calls the in-process server 240 to create a connection, the precalculation service 260 can call the precalculation server 210 and transfer the bytestream to the front-end. The precalculation server 210 can store the bytestream in a temporary file, open the temporary file in the application process 220, and start a refresh macro from the business analyzer addin 230. The business analyzer addin 230 can determine whether or not to refresh the workbook based on information included in the workbook (e.g., the workbook can be designed to include a time variable specifying how often to precalculate the workbook) and/or information provided by the precalculation server 210 (e.g., the precalculation server 210 may only send the workbook to the business analyzer addin 230 if the workbook needs to be refreshed). The business analyzer addin 230 can refresh the queries in the workbook using an OLAP (online analytical processing) component 270 of the back-end system. The OLAP component 270 facilitates handling of complex database queries, such as by using a snapshot of one or more relational databases, restructured into dimensional data. For example, the workbook can be an Excel file that includes one or more hidden sheets that specify how many queries are inside, which queries are inside, and the technical names for the queries; the analyzer 230 can read this information, gather the needed update information from the OLAP component 270, and write the new data into the spreadsheet for all the queries in the workbook, and then finish and save the workbook.

When the analyzer addin 230 finishes refreshing the workbook, the precalculation server 210 can generate a requested file type, including potentially multiple file types (e.g., printing against a generic driver allows the workbook to be saved in a native file format and also saved as a PDF document for mailing). For example, the interface used to generate the precalculation plan 250 can allow a user to select a workbook, insert a variant for the variables, select a server against which to calculate, select an output format, select a template to be used for an email body, and insert an email address to which the refreshed report(s) are to be mailed. Additionally, the analyzer addin 230 can generate a native format file, and the precalculation server 210 can read the bytestream from the generated file and send it back to the precalculation service 260. The precalculation service 260 can then give the new bytestream, and potentially other data, back to a requesting program, which can store the refreshed workbook and/or perform a requested operation (e.g., send the data by mail, put it in a spool, put it in an enterprise portal, etc.).

Thus, workbooks can be stored on the back-end system as the bytestream even if the back-end system cannot directly interpret the bytestream. The workbooks can include back-end system data and queries in addition to other information (e.g., text, charts, etc.). A back-end query can be a query name used by the back-end, and refreshing the workbook can involve interpreting the workbook at the front-end to identify a query, which is sent to the back-end to obtain the information defined by the query. The bytestream can then be updated on the front-end and put back in the back-end for storage.

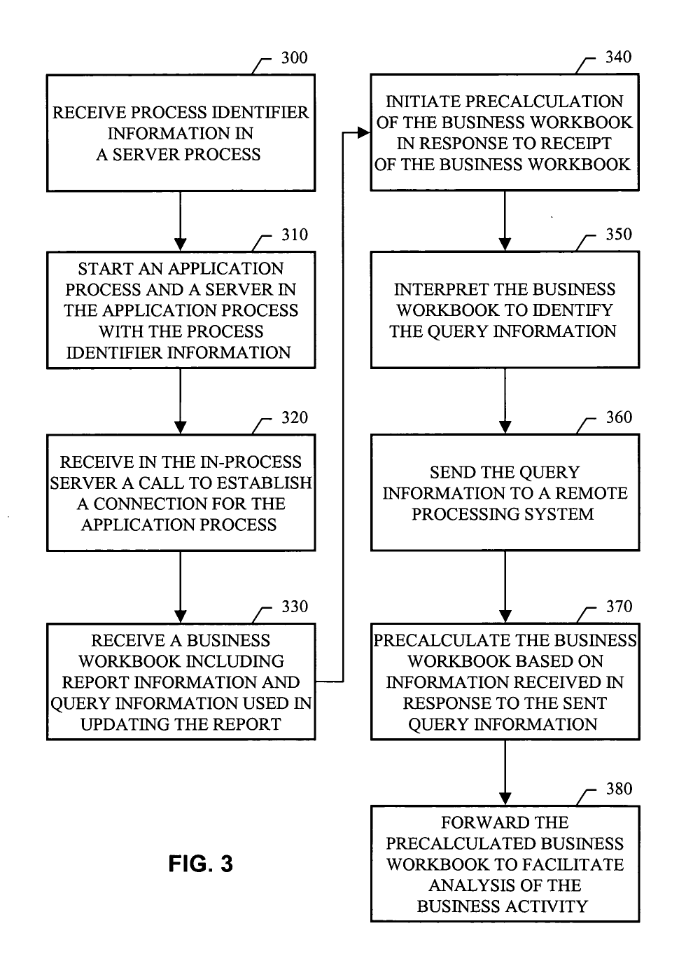

FIG. 3 is a flowchart illustrating business workbook precalculation. Process identifier information can be received in a server process at 300. The server process can then start an application process and a server in the application process with the process identifier information at 310. For example, the application process can be initiated, and a business analyzer addin can be loaded to the application process, where the loaded business analyzer addin starts the in-process server. A call can then be received in the in-process server to establish a connection for the application process at 320.

A business workbook to be precalculated can be received at 330. The business workbook can include report information concerning business activity and query information used in updating the report information. Precalculation of the business workbook can be initiated in response to receipt of the business workbook at 340. The business workbook can be interpreted to identify the query information at 350. The query information can be sent to a remote processing system at 360. The business workbook can be precalculated based on information received in response to the sent query information at 370. The precalculated business workbook can then be forwarded to facilitate analysis of the business activity at 380.

Forwarding the precalculated workbook can involve causing the application process to generate a file, reading the bytestream from the file, and sending the bytestream to the remote processing system. The business workbook can be the bytestream that is uninterpretable by the remote processing system, and interpreting the workbook can involve reading the bytestream to find the query information useable by the remote processing system. Moreover, initiating the precalculation can involve initiating precalculation of the business workbook in response to receipt of the business workbook and based on refresh information corresponding to the business workbook.

The business workbook precalculation illustrated in FIG. 3 can be performed on a front-end system as described above. A front-end system (e.g., a personal computer providing a Windows® service) can precalculate workbooks for different back-end systems. Additionally, multiple front-end systems can be provided for precalculating workbooks, and the larger system can include load balancing and administrative interfaces for controlling assignments of workbook precalculations to different front-end, precalculation server systems.

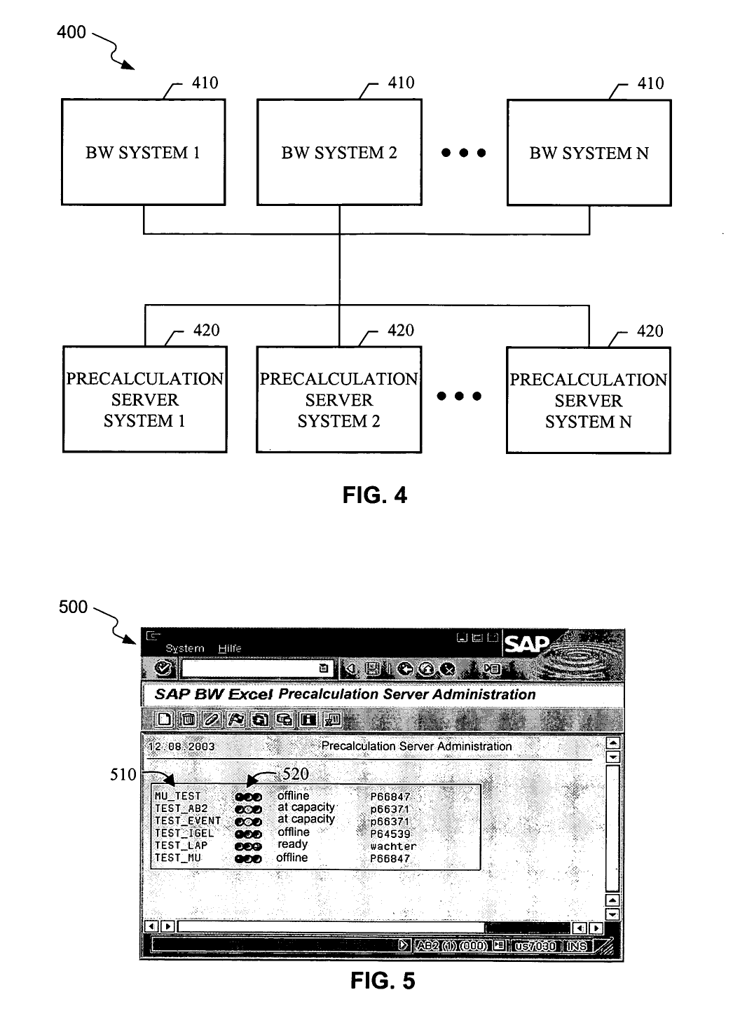

FIG. 4 is a block diagram illustrating a business workbook precalculation system 400. Multiple business warehouse information server systems 410 can be communicatively coupled with multiple precalculation server systems 420. A business warehouse information server system 410 can request the status of, and a log file for a precalculation server system 420. This information can be used in assignments of workbook precalculations.

FIG. 5 illustrates an example administrative interface 500. The interface 500 can be used to maintain precalculation server(s), allowing one to create, delete or precalculate against a precalculation server. Precalculation servers can be identified 510, and the status of these servers can be indicated using traffic light symbols 520. A red light can indicate the server is not reachable, and thus one cannot precalculate against it. A green light can indicate that the server is online and has free resources to precalculate a workbook. A yellow light can indicate that the server is calculating and has no resources free. A request can still be sent to such a server, but the calculation proceeds after the server has resources freed up. In this case, the request can be sent to a queue, which can be made viewable through the interface 500.

Precalculation of workbooks can be scheduled in advance as needed, such as scheduling overnight precalculation of workbooks that have a long refresh runtime, or scheduling precalculation of workbooks to occur after updates to the snapshot of the one or more relational databases (e.g., infocube data changes in the OLAP).

Various implementations of the systems and techniques described here can be realized in digital electronic circuitry, integrated circuitry, specially designed ASICs (application specific integrated circuits), computer hardware, firmware, software, and/or combinations thereof. These various implementations can include one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Although only a few embodiments have been described in detail above, other modifications are possible. The described systems and techniques can be used in a landscape with any business analytics application and any spreadsheet application. The logic flow depicted in FIG. 3 does not require the particular order shown, or sequential order, to achieve desirable results. In certain implementations, parallel processing may be preferable.

Other embodiments may be within the scope of the following claims.

1. A machine-implemented method comprising:
receiving a business workbook to be precalculated, the business workbook comprising report information concerning business activity and query information used in updating the report information;
initiating precalculation of the business workbook in response to receipt of the business workbook;
interpreting the business workbook to identify the query information;
sending the query information to a remote processing system;
precalculating the business workbook based on information received in response to the sent query information; and
forwarding the precalculated business workbook to facilitate analysis of the business activity.

2. The method of claim 1, further comprising:
receiving process identifier information in a server process;
starting, by the server process, an application process and a server in the application process with the process identifier information; and
receiving in the in-process server a call to establish a connection for the application process.

3. The method of claim 2, wherein said starting comprises:
initiating the application process; and
loading a business analyzer addin to the application process, wherein the loaded business analyzer addin starts the in-process server.

4. The method of claim 2, wherein said receiving the business workbook, said initiating precalculation, said interpreting, said sending, and said precalculating are performed by the application process, and said forwarding is performed by the server process and comprises:
causing the application process to generate a file;
reading a bytestream from the file; and
sending the bytestream to the remote processing system.

5. The method of claim 1, wherein the business workbook comprises a bytestream that is uninterpretable by the remote processing system, and said interpreting comprises reading the bytestream to find the query information useable by the remote processing system.

6. The method of claim 1, wherein said receiving the business workbook comprises receiving the business workbook from the remote processing system.

7. The method of claim 1, wherein said initiating precalculation comprises initiating precalculation of the business workbook in response to receipt of the business workbook and based on refresh information corresponding to the business workbook.

8. A system comprising:
a first processing system comprising at least one data server, the first processing system being configured to provide information about business activity, to retain a business workbook comprising report information concerning business activity and query information used to update the report information, and to send the business workbook to a second processing system for update; and
the second processing system configured to receive the business workbook, start an application process capable of reading the business workbook, and start an in-process server capable of receiving a call from the first processing system to establish a connection for the application process.

9. The system of claim 8, wherein the second processing system comprises a server process that initiates the application process and loads a business analyzer addin to the application process, wherein the business analyzer addin starts the in-process server.

10. The system of claim 9, wherein the application process with the loaded business analyzer addin precalculates the received business workbook upon instruction from the server process, and the server process is configured to forward the precalculated workbook to the first processing system.

11. The system of claim 8, wherein the application process uses an interpretation component in reading the business workbook.

12. The system of claim 8, wherein the first processing system comprises a business warehouse information server system, and the application process comprises a spreadsheet application.

13. The system of claim 8, wherein the business workbook comprises a bytestream that is uninterpretable by the first processing system absent the application process.

14. The system of claim 8, further comprising multiple precalculation server systems, including the second processing system, and wherein the first processing system comprises a business warehouse information server system that provides an administrative interface allowing selection of one or more of the multiple precalculation server systems to use in precalculating the business workbook.

15. A machine-implemented method for sidestepping and maintaining a security mechanism of a back-end system that prevents a connection from a front-end system to the back-end system from being shared over different process identifiers in a multitasking operating system of the front-end system, the method comprising:
starting an in-process server in a newly invoked process on the front-end system; and
receiving in the in-process server a call from the back-end system to establish a connection over a channel.

16. The method of claim 15, further comprising:
precalculating a received business workbook using the established connection to the back-end system to obtain information for updating the business workbook; and
forwarding the precalculated business workbook to facilitate analysis of business activities.

17. An article comprising a machine-readable medium storing instructions operable to cause one or more machines to perform operations comprising:
receiving a business workbook to be precalculated, the business workbook comprising report information concerning business activity and query information used in updating the report information;
initiating precalculation of the business workbook in response to receipt of the business workbook;
interpreting the business workbook to identify the query information;
sending the query information to a remote processing system;
precalculating the business workbook based on information received in response to the sent query information; and
forwarding the precalculated business workbook to facilitate analysis of the business activity.

18. The article of claim 17, wherein the operations further comprise:
receiving process identifier information in a server process;
starting, by the server process, an application process and a server in the application process with the process identifier information; and
receiving in the in-process server a call to establish a connection for the application process.

19. The article of claim 18, wherein said starting comprises:
initiating the application process; and
loading a business analyzer addin to the application process, wherein the loaded business analyzer addin starts the in-process server.

20. The article of claim 18, wherein said receiving the business workbook, said initiating precalculation, said interpreting, said sending, and said precalculating are performed by the application process, and said forwarding is performed by the server process and comprises:
causing the application process to generate a file;
reading a bytestream from the file; and
sending the bytestream to the remote processing system.

21. The article of claim 17, wherein the business workbook comprises a bytestream that is uninterpretable by the remote processing system, and said interpreting comprises reading the bytestream to find the query information useable by the remote processing system.

22. The article of claim 17, wherein said receiving the business workbook comprises receiving the business workbook from the remote processing system.

23. The article of claim 17, wherein said initiating precalculation comprises initiating precalculation of the business workbook in response to receipt of the business workbook and based on refresh information corresponding to the business workbook.
